(19) United States
(12) Patent Application Publication
(10) Pub. No.: US 2022/0030512 A1
(43) Pub. Date: Jan. 27, 2022

(54) METHOD FOR SELECTING THE TRANSPORT NETWORK LAYER ASSOCIATION (TNLA) WITHIN 5G RAN SYSTEMS

(71) Applicant: Mavenir Systems, Inc., Richardson, TX (US)

(72) Inventor: Srinivasan Sundararajan, Bangalore (IN)

(73) Assignee: Mavenir Systems, Inc., Richardson, TX (US)

(21) Appl. No.: 17/382,594

(22) Filed: Jul. 22, 2021

(30) Foreign Application Priority Data
Jul. 27, 2020 (IN) 202021032127

(51) Int. Cl. H04W 48/18; H04W 76/10

(52) U.S. Cl. CPC H04W 48/18; H04W 76/10

(57) ABSTRACT

A method of enabling a Cloud Radio Access Network (C-RAN)-compatible central unit (CU) to modify at least one dynamic Transport Network Layer Association (TNLA) in communication with a C-RAN-compatible distributed unit (DU) includes: generating, by the CU, a first TNLA distinct from an existing second TNLA; communicating, by the CU to the DU, assigned first and second weight factors associated with the first and second TNLAs, respectively, wherein i) the assigned first weight factor associated with the first TNLA indicates required selection, and ii) the assigned second weight factor for the second TNLA indicates required non-selection; establishing a new Stream Control Transport Protocol (SCTP) connection towards a gNB-CU IP address associated with the first TNLA; and automatically selecting, by the DU, the first TNLA for any new UE requiring service. The method can be performed using one of F1-C interface, Xn-C interface and E1 interface.

### BACKGROUND OF THE DISCLOSURE

### 1. Field of the Disclosure

The present disclosure relates to systems and methods for Radio Access Networks (RANs), and relates more particularly to Cloud RANs (C-RANs) for 4^{th}-Generation (4G) and 5^{th}-Generation (5G) based mobile networks.

### 2. Description of the Related Art

Conventional RANs were built employing an integrated unit where the entire RAN was processed. Conventional RANs implement the protocol stack (e.g., Physical Layer (PHY), Media Access Control (MAC), Radio Link Control (RLC), Packet Data Convergence Control (PDCP) layers) at the base station (also referred to as the evolved node B (eNodeB or eNB) for 4G LTE or next generation node B (gNodeB or gNB) for 5G NR). In addition, conventional RANs use application specific hardware for processing, which make the conventional RANs difficult to upgrade and evolve. As future networks evolve to have massive densification of networks to support increased capacity requirements, there is a growing need to reduce the capital and operating costs of RAN deployment and make the solution scalable and easy to upgrade.

Cloud-based Radio Access Networks (CRANs) are networks where a significant portion of the RAN layer processing is performed at a baseband unit (BBU), located in the cloud on commercial off the shelf servers, while the radio frequency (RF) and real-time critical functions can be processed in the remote radio unit (RRU), also referred to as the radio unit (RU). The BBU can be split into two parts: centralized unit (CU) and distributed unit (DU). CUs are usually located in the cloud on commercial off the shelf servers, while DUs can be distributed. The BBU may also be virtualized, in which case it is also known as vBBU. Radio Frequency (RF) interface and real-time critical functions can be processed in the remote radio unit (RRU).

The CUs and DUs are connected through the Stream Control Transport Protocol (SCTP) and through the control plane application protocol F1-C as mentioned in 3GPP TS38.473 F1-C Interface Specification. 3GPP standards also allow multiple SCTP association (e.g., using Transport Network Layer Association (TNLA)) between the CU and DU. The context of this invention is related to a method to select specific TNLA for UE, based on the load balancing criteria among all the available TNLAs.

In the C-RAN architecture, CU would require multiple IP address(es) for its communication with DU through the F1 interface. Multiple IP address(es) are needed for scalability and resiliency. 3GPP has defined a method to add multiple CU IP addresses between CU and DU, as explained below.

First, CU asks the DU to add new TNLA (new SCTP connection) using F1-C message gNB-CU Configuration Update by providing the new gNB-CU IP address. Second, DU initiates the SCTP connection (TNLA) towards the new gNB-CU IP address. Third, after the successful SCTP connection, DU replies to CU with gNB-CU Configuration Update Acknowledge message. After this procedure, more than one TNLAs are available between the CU and DU. When Radio Resource Control (RRC) connection needs to be established for any new UE (i.e., to service the new UE), DU sends the F1-C message “Initial UL RRC Message transfer” to CU. At this point in time, DU needs to choose one of the available TNLAs for this UE. As more than one TNLAs are available, DU needs to implement a method (e.g., involving an algorithm) via which specific TNLA shall be selected for the UE. Currently, 3GPP specification doesn't define any TNLA selection method for the UE.

Similar method (e.g., involving an algorithm) is needed in the Xn-C interface which can be provided between two gNBs (see, e.g., 3GPP TS38.423 Xn-C Interface Specification). This interface is mainly used to initiate the Xn-C handover for the UE. During the handover initiation, source gNB needs to select the specific TNLA among the available TNLAs between the gNBs.

Given the absence of a known method (e.g., an algorithm) for TNLA selection, DU may choose one of the available TNLAs in a round-robin or random manner. However, the selected TNLA might already be overloaded with many UEs, which leads to load misbalancing across the multiple TNLAs. To overcome the load misbalancing, CU needs to modify the TNLA of the UEs to ensure that loads (UEs) across the TNLAs are properly distributed. Accordingly, this conventional approach is a trial-and-error process, i.e., DU selecting the inappropriate TNLA and CU correcting the same, which is not an optimal solution.

Therefore, there is a need for an improved method for selecting a specific TNLA among multiple available TNLAs, e.g., a method to select a specific TNLA for any new UEs based on the load balancing criteria among all the available TNLAs.

### SUMMARY OF THE DISCLOSURE

The present disclosure provides a method for selecting a specific TNLA among multiple available TNLAs, e.g., a method to select a specific TNLA for any new UEs based on the load balancing criteria among all the available TNLAs. The TNLA selection according to an example embodiment of the present disclosure applies to both CU control plane (CU-CP) and CU user plane (CU-UP).

The example method according to the present disclosure provides addition of weight factor for each TNLA.

In a first example embodiment, e.g., for F1-C interface, the present disclosure defines weight factor for each TNLA between CU and DU. CU determines the weight factor for each TNLA based on its operating conditions and/or capacity of each TNLA. CU then communicates the determined weight factor for each TNLA to DU using the F1-C message “gNB-CU Configuration Update message”. DU stores the weight factor for each TNLA and uses the weight factor to select the specific TNLA for any new UEs.

In a second example embodiment, e.g., for Xn-C interface, CU determines the weight factor for each TNLA based on its operating conditions and/or capacity of each TNLA, and CU communicates the determined weight factor for each TNLA to peer gNB CU using the Xn-C interface. Peer gNB CU stores the weight factor for each TNLA and uses the weight factor to select the specific TNLA for any new UEs towards the CU. For this example embodiment, the relevant 3GPP specification reference is 3GPP TS38.423.

In a third example embodiment, e.g., for E1 interface, CU user plane (CU-UP) determines the weight factor for each TNLA based on its operating conditions and/or capacity of each TNLA, and CU-UP communicates the determined weight factor for each TNLA to CU control plane (CU-CP) using the E1 interface. CU-CP stores the weight factor for each TNLA and uses the weight factor to select the specific TNLA for any new bearer creation for the UEs towards CU-UP. For this example embodiment, the relevant 3GPP specification reference is 3GPP TS38.463.

The present disclosure is intended to encompass 4G, 5G and other wireless systems that are C-RAN compliant.

### BRIEF DESCRIPTION OF THE FIGURES

FIG. 1 illustrates an example embodiment of a method according to the present disclosure.

FIG. 2 illustrates another example embodiment of a method according to the present disclosure.

FIG. 3 illustrates another example embodiment of a method according to the present disclosure.

### DETAILED DESCRIPTION

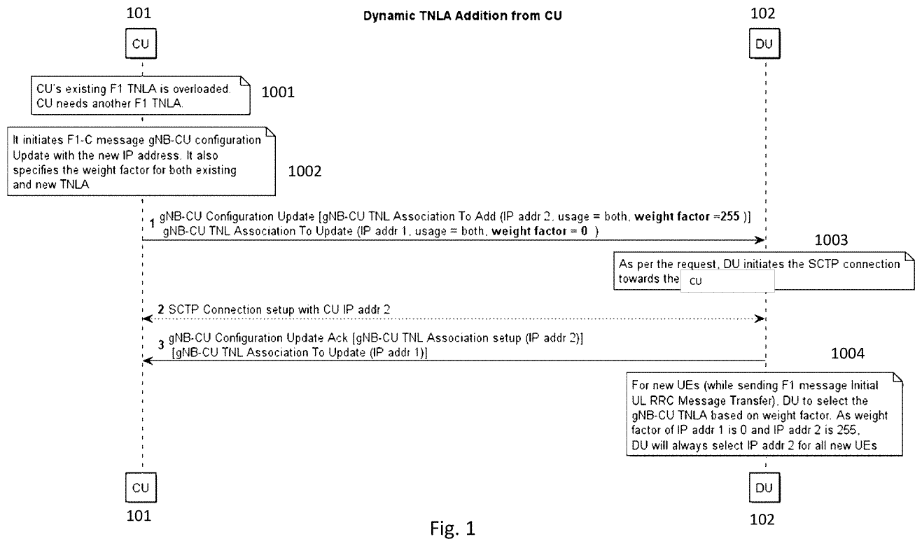

FIG. 1 illustrates an example embodiment of a method according to the present disclosure, e.g., utilizing F1-C interface, which example embodiment provides a dynamic TNLA addition procedure from CU, i.e., how CU 101 shall request DU 102 to add new TNLA with a weight factor. In this example, a new TNLA is needed at CU's F1 interface due to the existing TNLA being overloaded, i.e., the existing TNLA IP address (IP address 1) is at its maximum capacity in terms of handling new user equipments (UEs), as shown at block 1001. Once a new TNLA is created, CU 101 then communicates, e.g., as summarized in block 1002, the determined weight factor for each TNLA to DU 102 using the F1-C message “gNB-CU Configuration Update” message. CU 101 wants all new UEs to use the newly created TNLA, so CU 101 i) sets the weight factor for the existing TNLA (associated with IP address 1), e.g., as zero, and ii) sets the weight factor for the newly created TNLA, e.g., as 255, which assignments are illustrated with the process arrow designated “1” in FIG. 1. As per the request, DU 102 initiates the Stream Control Transport Protocol (SCTP) connection towards the CU 101, as shown at block 1003. The initiation of the SCTP connection towards the new gNB-CU IP address (e.g., CU IP address 2) is illustrated with the process arrow designated “2” in FIG. 1. After the successful SCTP connection, DU 102 shall reply to CU 101 with “gNB-CU Configuration Update Acknowledge” message, as illustrated with the process arrow designated “3” in FIG. 1. With these weight assignments, for any new UEs (as represented by Radio Resource Control (RRC) connection), DU 102 will automatically select the new TNLA, as shown at block 1004. Although zero and 255 are used as example weight factors in this embodiment, other relative weight factors can be utilized for implementing the selection of the new TNLA, e.g., a first weight factor (e.g., any non-zero weight factor) indicating a required selection of the new TNLA, and a second weight factor indicating a required non-selection of the existing TNLA (e.g., zero weight factor). Once the load of both TNLAs is equalized, the respective weight factors can be updated by CU 101 to be the same value for both TNLAs. Although the example embodiment of the method shown in FIG. 1 has been explained in connection with F1-C interface, the example method is also applicable for E1 and Xn-c interfaces.

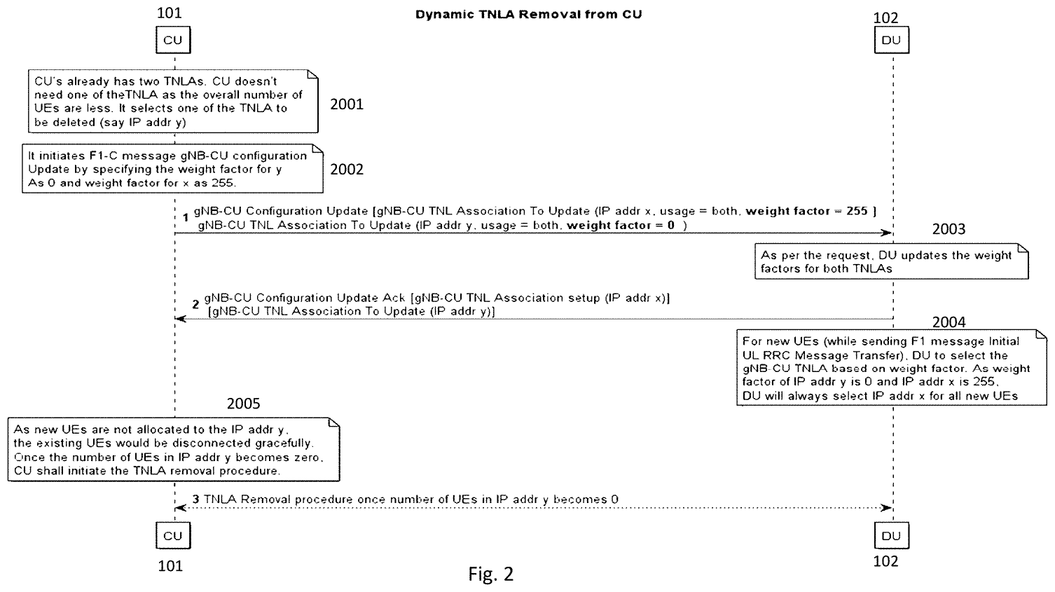

FIG. 2 illustrates an example embodiment of a method according to the present disclosure, e.g., utilizing F1-C interface, which example embodiment provides a dynamic TNLA deletion procedure from CU 101, i.e., when CU 101 wants to remove one of the TNLAs, e.g., due to low resource usage among the TNLAs. As illustrated in block 2001, CU already has two available TNLAs in this example, but CU doesn't need one of the TNLAs because the overall number of UEs is low. In this example embodiment, instead of terminating the TNLA connection abruptly, CU 101 asks DU 102 not to allocate new UEs to the “to-be-deleted” TNLA (e.g., associated with IP address y). As summarized in block 2002, CU 101 initiates the process by communicating the determined weight factor for each TNLA to DU 102 using the F1-C message “gNB-CU Configuration Update” message. CU 101 wants all new UEs to use the “to-be-retained” TNLA (e.g., associated with IP address x), so CU 101 i) sets the weight factor for the “to-be-deleted” TNLA (associated with IP address y), e.g., as zero, and ii) sets the weight factor for the “to-be-retained” TNLA, e.g., as 255, which assignments are illustrated with the process arrow designated “1” in FIG. 2. As per the request, DU 102 updates the respective weight factors for the two TNLAs, and DU 102 sends to CU 101 a “gNB-CU Configuration Update Acknowledge” message, as shown in block 2003 and illustrated with the process arrow designated “2” in FIG. 2. With these weight assignments, for any new UEs, DU 102 will automatically select the “to-be-retained” TNLA (associated with IP address x), as shown at block 2004. As new UEs are not allocated to the “to-be-deleted” TNLA (associated with IP address y), the existing UEs will be disconnected from the “to-be-deleted” TNLA gradually and gracefully, as summarized in block 2005. Once the number of UEs in the “to-be-deleted” TNLA (associated with IP address y) becomes 0, TNLA removal procedure (e.g., as specified in 3GPP TS38.473) for the “to-be-deleted” TNLA can be triggered (as illustrated with the process arrow designated “3” in FIG. 2), thereby achieving a graceful shutdown for the “to-be-deleted” TNLA. Although zero and 255 are used as example weight factors in this embodiment, other relative weight factors can be utilized for implementing the selection of the “to-be-retained” TNLA, e.g., a first weight factor indicating a required selection of the “to-be-retained” TNLA (e.g., any non-zero weight factor), and a second weight factor indicating a required non-selection of the “to-be-deleted” TNLA (e.g., zero weight factor). Although the example embodiment of the method shown in FIG. 2 has been explained in connection with F1-C interface, the example method is also applicable for E1 and Xn-c interfaces.

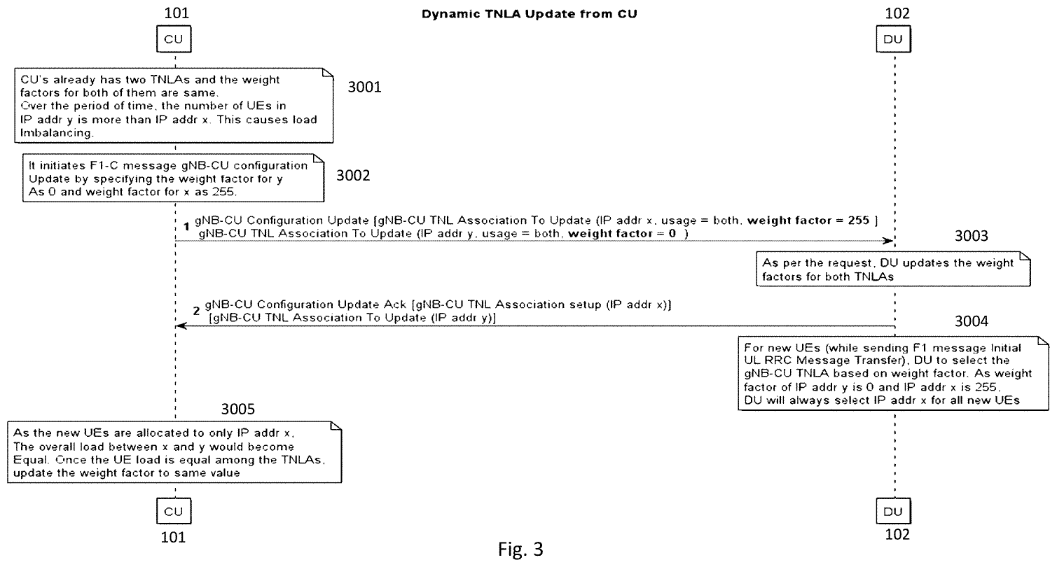

FIG. 3 illustrates an example embodiment of a method according to the present disclosure, e.g., utilizing F1-C interface, which example embodiment provides a dynamic TNLA update procedure from CU 101 to address a load imbalance that develops among multiple TNLAs, e.g., when the number of UEs in one TNLA becomes less than the number of UEs in the other TNLA over time, which scenario is summarized in block 3001. In this example scenario, CU 101 achieves dynamic load balancing by having all new UEs selecting the “least loaded” TNLA (associated with IP address x) over the “most loaded TNLA” (associated with IP address y). As summarized in block 3002, CU 101 initiates the process by communicating the determined weight factor for each TNLA to DU 102 using the F1-C message “gNB-CU Configuration Update” message. CU 101 wants all new UEs to use the “least loaded” TNLA (e.g., associated with IP address x), so CU 101 i) sets the weight factor for the “most loaded” TNLA (associated with IP address y), e.g., as zero, and ii) sets the weight factor for the “least loaded” TNLA (associated with IP address x), e.g., as 255, which assignments are illustrated with the process arrow designated “1” in FIG. 3. As per the request, DU 102 updates the respective weight factors for the two TNLAs, as shown in block 3003, and DU 102 sends to CU 101 a “gNB-CU Configuration Update Acknowledge” message, as illustrated with the process arrow designated “2” in FIG. 3. With these weight assignments, for any new UEs, DU 102 will automatically select the “least loaded” TNLA (associated with IP address x, having a weight factor of 255), as shown at block 3004. As new UEs are not allocated to the “most loaded” TNLA (associated with IP address y) and only allocated to the “least loaded” TNLA (associated with IP address x), over time the overall UE load imbalance between the “most loaded” TNLA (associated with IP address y) and the “least loaded” TNLA (associated with IP address x) disappears. Although zero and 255 are used as example weight factors in this embodiment, other relative weight factors can be utilized for implementing the selection of the “least loaded” TNLA, e.g., a first weight factor indicating a required selection of the “least loaded” TNLA (e.g., any non-zero weight factor), and a second weight factor indicating a required non-selection of the “most loaded” TNLA (e.g., zero weight factor). Once the UE load for the “least loaded” TNLA has become equal to the UE load for the “most loaded” TNLA, the respective weight factors can be updated by CU 101 to be the same value for both TNLAs, as summarized in block 3005. Although the example embodiment of the method shown in FIG. 3 has been explained in connection with F1-C interface, the example method is also applicable for E1 and Xn-c interfaces.

In another example embodiment, e.g., utilizing Xn-C interface, CU determines the weight factor for each TNLA based on its operating conditions and/or capacity of each TNLA, and CU communicates the determined weight factor for each TNLA to peer gNB CU using the Xn-C interface. Peer gNB CU stores the weight factor for each TNLA and uses the weight factor to select the specific TNLA for any new UEs towards the CU. For this example embodiment, 3GPP specification reference is 38.423.

In yet another example embodiment, e.g., utilizing E1 interface, CU user plane (CU-UP) determines the weight factor for each TNLA based on its operating conditions and/or capacity of each TNLA, and CU-UP communicates the determined weight factor for each TNLA to CU control plane (CU-CP) using the E1 interface. CU-CP stores the weight factor for each TNLA and uses the weight factor to select the specific TNLA for any new bearer creation for the UEs towards CU-UP. For this example embodiment, 3GPP specification reference is 38.463.

In connection with the example embodiments described herein, several changes are proposed for 3GPP specifications, as explained in detail below.

### Changes to 3GPP TS38.473 Specification

Specific changes to F1-C interface specification (TS38.473) are described below, and similar changes are applicable in the other 3GPP specifications relating to Xn-C interface (TS38.423) and E1 interface (TS38.463).

In section “8.2.5 gNB-CU Configuration”, the following changes shall be made (newly added text is underlined):
If the TNL Association usage or the TNL Address Weight Factor IE is included in the gNB-CU TNL Association To Add List IE or the gNB-CU TNL Association To Update List IE, the gNB-DU node shall, if supported, use it as described in TS 38.472.

The following new IE shall be added:
a.b.c.d TNL Address Weight Factor
This IE indicates the weight factor of the TNL address.

| IE/ | | | IE type and | |
|---|---|---|---|---|
| Group Name | Presence | Range | reference | Semantics description |
| TNL Address | M | | INTEGER | Value 0 indicates the TNL |
| Weight | | | (0 . .. 255) | address is not permitted for |
| Factor | | | | the initial UL RRC Message |
| | | | | transfer. If the value for each |
| | | | | TNL address is the same, |
| | | | | gNB-DU shall |
| | | | | select the TNL address |
| | | | | alternatively for the UEs |

As part of section “9.2.1.10 GNB-CU CONFIGURATION UPDATE”, the following new IEs shall be added (newly added text is underlined):

| | | | IE type and | Semantics | | Assigned |
|---|---|---|---|---|---|---|
| IE/Group Name | Presence | Range | reference | description | Criticality | Criticality |
| gNB-CU TNL Association | | 0 . . . 1 | | | YES | ignore |
| To Add List | | | | | | |
| >gNB-CU TNL Association | | 1 . . . <maxnoofTNL- | | | EACH | ignore |
| To Add Item IEs | | Associations> | | | | |
| >>TNL Association | M | | CP | Transport | — | |
| Transport Layer | | | Transport | Layer | | |
| Information | | | Layer | Address of | | |
| | | | Address | the gNB-CU. | | |
| | | | 9.3.2.4 | | | |
| >>TNL Association Usage | M | | ENUMERATED | Indicates | — | |
| | | | (ue, non- | whether the | | |
| | | | ue, both, . . . ) | TNL | | |
| | | | | association | | |
| | | | | is only used | | |
| | | | | for UE- | | |
| | | | | associated | | |
| | | | | signalling, or | | |
| | | | | non-UE- | | |
| | | | | associated | | |
| | | | | signalling, or | | |
| | | | | both. For | | |
| | | | | usage of this | | |
| | | | | IE, refer to | | |
| | | | | TS 38.472 | | |
| | | | | [22]. | | |
| >>TNL Address Weight | O | | a.b.c.d | | — | |
| Factor | | | | | | |
| gNB-CU TNL Association | | 0 . . . 1 | | | YES | ignore |
| To Update List | | | | | | |
| >gNB-CU TNL Association | | 1 . . . <maxnoofTNL- | | | EACH | ignore |
| To Update Item IEs | | Associations> | | | | |
| >>TNL Association | M | | CP | Transport | — | |
| Transport Layer Address | | | Transport | Layer | | |
| | | | Layer | Address of | | |
| | | | Address | the gNB-CU. | | |
| | | | 9.3.2.4 | | | |
| >>TNL Association Usage | O | | ENUMERATED | Indicates | — | |
| | | | (ue, non- | whether the | | |
| | | | ue, both, . . . ) | TNL | | |
| | | | | association | | |
| | | | | is only used | | |
| | | | | for UE- | | |
| | | | | associated | | |
| | | | | signalling, or | | |
| | | | | non-UE- | | |
| | | | | associated | | |
| | | | | signalling, or | | |
| | | | | both. For | | |
| | | | | usage of this | | |
| | | | | 1E, refer to | | |
| | | | | TS 38.472 | | |
| | | | | [22]. | | |
| >>TNL Address Weight | O | | a.b.c.d | | — | |
| Factor | | | | | | |

ASN.1 Changes to 3GPP TS38.473

The following changes shall be made (text additions underlined):

```
TNLAddressWeightFactor ::= INTEGER (0 . . . 255)
GNB-CU-TNL-Association-To-Add-Item ::= SEQUENCE {
  tNLAssociationTransportLayerAddress CP-TransportLayerAddress ,
  tNLAssociationUsage TNLAssociationUsage,
  iE-Extensions ProtocolExtensionContainer { {
GNB-CU-TNL-Association-To-Add-Item-ExtIEs} } OPTIONAL
}
GNB-CU-TNL-Association-To-Add-Item-ExtIEs F1AP-PROTOCOL-
EXTENSION ::= {
  tNLAddressWeightFactor TNLAddressWeightFactor
}
GNB-CU-TNL-Association-To-Update-Item::= SEQUENCE {
  tNLAssociationTransportLayerAddress CP-TransportLayerAddress ,
  tNLAssociationUsage TNLAssociationUsage
OPTIONAL,
  iE-Extensions ProtocolExtensionContainer { {
GNB-CU-TNL-Association-To-Update-Item-ExtIEs} } OPTIONAL
}
GNB-CU-TNL-Association-To-Update-Item-ExtIEs F1AP-
PROTOCOL-EXTENSION
::= {
  tNLAddressWeightFactor TNLAddressWeightFactor
}
```

### Changes to 3GPP 38.401 Specification

In section “8.8 Multiple TNLAs for F1-C”, the following shall be added:
gNB-DU shall select the TNLA for the UE based on the TNL address weight factor IE provided by gNB-CU

As a summary, several examples of the method according to the present disclosure are provided.

A first example of the method according to the present disclosure provides a method enabling a Cloud Radio Access Network (C-RAN)-compatible central unit (CU) to modify at least one dynamic Transport Network Layer Association (TNLA) in communication with a C-RAN-compatible distributed unit (DU), which method comprises:
generating, by the CU, a first TNLA distinct from an existing second TNLA;
communicating, by the CU to the DU, assigned first and second weight factors associated with the first and second TNLAs, respectively, wherein at least one of i) the assigned first weight factor associated with the first TNLA indicates required selection, and ii) the assigned second weight factor for the second TNLA indicates required non-selection;
establishing a new Stream Control Transport Protocol (SCTP) connection towards a gNB-CU IP address associated with the first TNLA; and
automatically selecting, by the DU, the first TNLA for any new UE requiring service.

In a second example of the method modifying the first example of the method, the first and second weight factors are communicated to the DU using a “gNB-CU Configuration Update” message.

In a third example of the method modifying the second example of the method, the method further comprises:
transmitting, by the DU to the CU, a “gNB-CU Configuration Update Acknowledge” message, after the establishing of the SCTP connection.

A fourth example of the method according to the present disclosure provides a method for enabling a Cloud Radio Access Network (C-RAN)-compatible central unit (CU) to modify at least one dynamic Transport Network Layer Association (TNLA) in communication with a C-RAN-compatible distributed unit (DU), which method comprises:
communicating, by the CU to the DU, assigned first weight factor associated with a first TNLA and assigned second weight factor associated with a second TNLA, wherein at least one of i) the assigned first weight factor associated with the first TNLA indicates required selection, and ii) the assigned second weight factor for the second TNLA indicates required non-selection;
updating, by the DU, the first and second weight factors for the first and second TNLAs, respectively; and
automatically selecting, by the DU, the first TNLA for any new UE requiring service.

In a fifth example of the method modifying the fourth example of the method, the first and second weight factors are communicated to the DU using a “gNB-CU Configuration Update” message.

In a sixth example of the method modifying the fourth example of the method, the first TNLA is the TNLA to be retained, and the second TNLA is the TNLA to be deleted; and the number of UEs assigned to the second TNLA is reduced to zero after a period of time based on the assigned first and second weight factors.

In a seventh example of the method modifying the sixth example of the method, the method further comprises: initiating a deletion of the second TNLA after the number of UEs assigned to the second TNLA is reduced to zero.

In an eight example of the method modifying the fourth example of the method, the first TNLA is initially less loaded with UEs in comparison to the second TNLA; and the number of UEs assigned to the first TNLA becomes substantially equal to the number of UEs assigned to the second TNLA after a period of time based on the assigned first and second weight factors.

In a ninth example of the method modifying the eighth example of the method, the first and second weight factors are communicated to the DU using a “gNB-CU Configuration Update” message.

In a tenth example of the method modifying the eighth example of the method, the method further comprises: updating, by the CU, the first and second weight factors to be equal after the number of UEs assigned to the first TNLA becomes substantially equal to the number of UEs assigned to the second TNLA.

In an eleventh example of the method modifying the first example of the method, at least the communicating step is performed using F1-C interface.

In a twelfth example of the method modifying the fourth example of the method, at least the communicating step is performed using F1-C interface.

A thirteenth example of the method according to the present disclosure provides a method of enabling a first Cloud Radio Access Network (C-RAN)-compatible central unit (CU) to modify at least one dynamic Transport Network Layer Association (TNLA) in communication with a second C-RAN-compatible CU, which method comprises:
communicating via Xn-C interface, by the first CU to the second CU, assigned first weight factor associated with a first TNLA and assigned second weight factor associated with a second TNLA, wherein at least one of i) the assigned first weight factor associated with the first TNLA indicates required selection, and ii) the assigned second weight factor for the second TNLA indicates required non-selection;
storing, by the second CU, the first and second weight factors for the first and second TNLAs, respectively; and
automatically selecting, by the second CU, the first TNLA for any new UE requiring service.

A fourteenth example of the method according to the present disclosure provides a method of enabling a Cloud Radio Access Network (C-RAN)-compatible central unit (CU) to modify at least one dynamic Transport Network Layer Association (TNLA), which method comprises:
communicating via E1 interface, by CU user plane (CU-UP) to CU control plane (CU-CP), assigned first weight factor associated with a first TNLA and assigned second weight factor associated with a second TNLA, wherein at least one of i) the assigned first weight factor associated with the first TNLA indicates required selection, and ii) the assigned second weight factor for the second TNLA indicates required non-selection;
storing, by the CU-CP, the first and second weight factors for the first and second TNLAs, respectively; and
automatically selecting, by the CU-CP, the first TNLA for any new UE requiring service.

### Glossary of Terms

3GPP: Third generation partnership project
CAPEX: Capital Expenditure
COTS: Commercial off-the-shelf
CP: Control plane
C-RAN: cloud radio access network
CU: Central unit
DU: Distribution unit
FDD: Frequency-division duplex
gNB: Next Generation Node B
NR: New radio
OPEX: Operational Expenditure
RAN: Radio Access Network
RRC: Radio Resource Control
SCTP: Stream Control Transport Protocol
TNLA: Transport Network Layer Association
UE: User Equipment
UP: User plane

What is claimed is:

1. A method of enabling a Cloud Radio Access Network (C-RAN)-compatible central unit (CU) to modify at least one dynamic Transport Network Layer Association (TNLA) in communication with a C-RAN-compatible distributed unit (DU), comprising:
generating, by the CU, a first TNLA distinct from an existing second TNLA;
communicating, by the CU to the DU, assigned first and second weight factors associated with the first and second TNLAs, respectively, wherein at least one of i) the assigned first weight factor associated with the first TNLA indicates required selection, and ii) the assigned second weight factor for the second TNLA indicates required non-selection;
establishing a new Stream Control Transport Protocol (SCTP) connection towards a gNB-CU IP address associated with the first TNLA; and
automatically selecting, by the DU, the first TNLA for any new UE requiring service.

2. The method according to claim 1, wherein the first and second weight factors are communicated to the DU using a “gNB-CU Configuration Update” message.

3. The method according to claim 2, further comprising:
transmitting, by the DU to the CU, a “gNB-CU Configuration Update Acknowledge” message, after the establishing of the SCTP connection.

4. A method of enabling a Cloud Radio Access Network (C-RAN)-compatible central unit (CU) to modify at least one dynamic Transport Network Layer Association (TNLA) in communication with a C-RAN-compatible distributed unit (DU), comprising:
communicating, by the CU to the DU, assigned first weight factor associated with a first TNLA and assigned second weight factor associated with a second TNLA, wherein at least one of i) the assigned first weight factor associated with the first TNLA indicates required selection, and ii) the assigned second weight factor for the second TNLA indicates required non-selection;
updating, by the DU, the first and second weight factors for the first and second TNLAs, respectively; and
automatically selecting, by the DU, the first TNLA for any new UE requiring service.

5. The method according to claim 4, wherein the first and second weight factors are communicated to the DU using a “gNB-CU Configuration Update” message.

6. The method according to claim 4, wherein:
the first TNLA is the TNLA to be retained, and the second TNLA is the TNLA to be deleted; and
the number of UEs assigned to the second TNLA is reduced to zero after a period of time based on the assigned first and second weight factors.

7. The method according to claim 6, further comprising:
initiating a deletion of the second TNLA after the number of UEs assigned to the second TNLA is reduced to zero.

8. The method according to claim 4, wherein:
the first TNLA is initially less loaded with UEs in comparison to the second TNLA; and
the number of UEs assigned to the first TNLA becomes substantially equal to the number of UEs assigned to the second TNLA after a period of time based on the assigned first and second weight factors.

9. The method according to claim 8, wherein the first and second weight factors are communicated to the DU using a “gNB-CU Configuration Update” message.

10. The method according to claim 8, further comprising:
updating, by the CU, the first and second weight factors to be equal after the number of UEs assigned to the first TNLA becomes substantially equal to the number of UEs assigned to the second TNLA.

11. The method according to claim 1, wherein at least the communicating step is performed using F1-C interface.

12. The method according to claim 4, wherein at least the communicating step is performed using F1-C interface.

13. A method of enabling a first Cloud Radio Access Network (C-RAN)-compatible central unit (CU) to modify at least one dynamic Transport Network Layer Association (TNLA) in communication with a second C-RAN-compatible CU, comprising:
communicating via Xn-C interface, by the first CU to the second CU, assigned first weight factor associated with a first TNLA and assigned second weight factor associated with a second TNLA, wherein at least one of i) the assigned first weight factor associated with the first TNLA indicates required selection, and ii) the assigned second weight factor for the second TNLA indicates required non-selection;
storing, by the second CU, the first and second weight factors for the first and second TNLAs, respectively; and
automatically selecting, by the second CU, the first TNLA for any new UE requiring service.

14. A method of enabling a Cloud Radio Access Network (C-RAN)-compatible central unit (CU) to modify at least one dynamic Transport Network Layer Association (TNLA), comprising:
communicating via E1 interface, by CU user plane (CU-UP) to CU control plane (CU-CP), assigned first weight factor associated with a first TNLA and assigned second weight factor associated with a second TNLA, wherein at least one of i) the assigned first weight factor associated with the first TNLA indicates required selection, and ii) the assigned second weight factor for the second TNLA indicates required non-selection;
storing, by the CU-CP, the first and second weight factors for the first and second TNLAs, respectively; and
automatically selecting, by the CU-CP, the first TNLA for any new UE requiring service.
